(19) United States
(12) Patent Application Publication
(10) Pub. No.: US 2014/0362748 A1
(43) Pub. Date: Dec. 11, 2014

(54) LOGICAL OPERATING BANDS FOR SCALABLE UMTS

(71) Applicant: QUALCOMM Incorporated, San Diego, CA (US)

(72) Inventors: Peter Anthony BARANY, San Diego, CA (US); Sathish Krishnamoorthy, Hyderabad (IN); Valibabu Saladi, San Diego, CA (US); Sharad Deepak Sambhwani, San Diego, CA (US)

(73) Assignee: QUALCOMM Incorporated, San Diego, CA (US)

(21) Appl. No.: 14/091,933

(22) Filed: Nov. 27, 2013

Related U.S. Application Data
(60) Provisional application No. 61/831,745, filed on Jun. 6, 2013.

(51) Int. Cl. H04W 72/04; H04W 88/06; H04L 5/14

(52) U.S. Cl. CPC H04W 72/0406; H04L 5/14; H04W 88/06
USPC 370/281

(57) ABSTRACT

Apparatus and methods are described for selecting or identifying a first band number from one or more additional band numbers mapped to a frequency division duplexing (FDD) band used in universal mobile telecommunications (UMTS). The one or more additional band numbers may be different from a second band number assigned to the FDD band. Each of the one or more additional band numbers may correspond to a different factor N (e.g., N=2, N=4) for use in UMTS scaling. A signal indicative of the first band number may be transmitted to, for example, a network entity, where the signal indicates support of UMTS scaling operations in the FDD band using the factor N corresponding to the first band number.

### CLAIM OF PRIORITY UNDER 35 U.S.C. §119

The present application for patent claims priority to U.S. Provisional Application No. 61/831,745 entitled “NEW OPERATING BANDS FOR SCALABLE UMTS” filed Jun. 6, 2013, and assigned to the assignee hereof and hereby expressly incorporated by reference herein.

### REFERENCE TO RELATED APPLICATIONS FOR PATENT

The present application for patent is related to the U.S. patent application Ser. No. 13/707,111 entitled “PROVIDING FOR MOBILITY FOR FLEXIBLE BANDWIDTH CARRIER SYSTEMS,” filed Dec. 6, 2013, and assigned to the assignee hereof and hereby expressly incorporated by reference herein.

### BACKGROUND

Aspects of the present disclosure relate generally to wireless communication systems, and more particularly, to apparatus and methods for improving signaling in scalable UMTS (S-UMTS).

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

With the deployment of scalable UMTS (S-UMTS) along with UMTS, there is a need to implement signaling mechanisms that can distinguish between UMTS and S-UMTS. Thus, in this case, improved signaling to support S-UMTS is desired.

### SUMMARY

The following presents a simplified summary of one or more aspects in order to provide a basic understanding of such aspects. This summary is not an extensive overview of ail contemplated aspects, and is intended to neither identify key or critical elements of all aspects nor delineate the scope of any or ail aspects. Its sole purpose is to present some concepts of one or more aspects in a simplified form as a prelude to the more detailed description that is presented later.

In one aspect, a method for wireless communications is provided that includes selecting a first band number from one or more additional band numbers mapped to a frequency division duplexing (FDD) band used in universal mobile telecommunications (UMTS), where the one or more additional band, numbers are different from a second band, number assigned to the FDD band, and where each of the one or more additional band numbers corresponds to a different factor N for use in UMTS scaling. The method may further include transmitting a signal indicative of the first band number, where the signal indicates support of UMTS scaling operations in the FDD band using the factor N corresponding to the first band number.

In another aspect, an apparatus for wireless communications is provided that includes a processing system configured to select a first band number from one or more additional band numbers mapped to an FDD band used in UMTS, where the one or more additional band numbers are different from a second band number assigned, to the FDD band, and where each of the one or more additional band numbers corresponds to a different factor N for use in UMTS scaling. The processing system may also be configured to transmit a signal indicative of the first band number, where the signal indicates support of UMTS scaling operations in the FDD band using the factor N corresponding to the first band number.

In a further aspect, a method for wireless communications is provided that includes receiving, from a user equipment (UE), a first signal that identifies a first band number indicative of support at the UE of communications using UMTS scaling operations in an FDD band, where the first band number is one of one or more additional band, numbers mapped to the FDD band that are different from a second band number assigned to the FDD band, and wherein each of the one or more additional band numbers corresponds to a different factor N for use in the UMTS scaling operations, and performing radio resource management based on a factor N corresponding to the first band number.

These and other aspects of the invention will become more fully understood upon a review of the detailed description, which follows.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic block diagram of one aspect of a system for improved S-UMTS.

FIG. 2 illustrates an example UICC application architecture in aspects of the system of FIG. 1.

FIG. 3 is a schematic block diagram of an example idle mode process in aspects of the system of FIG. 1.

FIG. 4 illustrates an example access technology identifier coding in aspects of the system of FIG. 1.

FIGS. 5 and 6 are flowcharts of aspects of methods of the system of FIG. 1.

FIG. 7 is a diagram illustrating an example of a hardware implementation for an apparatus of FIG. 1 employing a processing system.

FIG. 8 is a block diagram conceptually illustrating an example of a telecommunications system including aspects of the system of FIG. 1.

FIG. 9 is a conceptual diagram illustrating an example of an access network including aspects of the system of FIG. 1.

FIG. 10 is a block diagram conceptually illustrating an example of a Node B in communication with a UE in a telecommunications system, including aspects of the system of FIG. 1.

### DETAILED DESCRIPTION

The detailed description set forth below in connection with the appended drawings is intended as a description of various configurations and is not intended, to represent the only configurations in which the concepts described herein may be practiced. The detailed, description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In 3GPP, scalable UMTS (S-UMTS) includes 3.84 megachips-per-second (Mcps)/2 (known as S-UMTS N=2) and 3.84 Mcps/4 (known as S-UMTS N=4). In one example aspect of S-UMTS, in addition to the chip rate being reduced, by a factor 1/N, time is also increased (e.g., dilated) by a factor N (e.g., a 10 ms radio frame in normal UMTS becomes an N*10 ms radio frame in S-UMTS). However, some other example aspects of S-UMTS may not include time dilation.

Conventionally, in 3GPP, the factor N (e.g., N=2 or 4) can be explicitly defined in the 3GPP specifications in order to standardize S-UMTS and thereby differentiate it from normal UMTS during various procedures such as the broadcasting of neighbor cell list information, PLMN selection (including cell selection/re-selection), measurement control procedures, mobility procedures, etc. However, the present aspects provide a signaling mechanism that makes it possible to implicitly differentiate between normal UMTS and S-UMTS N=2 and N=4 during network operation by defining one or more new FDD bands (in, for example, TS 25.101) with unique UTRA absolute radio frequency channel number (UARFCN) values but with the same (or approximately the same or at least partially overlapping) downlink and uplink frequency ranges relative to the existing normal UMTS FDD bands, A unique set of UARFCNs for a particular FDD band may refer to a set of UARFCNs assigned or determined for that particular FDD band that are different from a set of UARFCNs assigned or determined for another FDD band. Alternatively, in some present aspects, the one or more new S-UMTS FDD bands may have a downlink and uplink frequency range different from an existing normal UMTS FDD band (e.g., if S-UMTS is deployed in a frequency range not specified in TS 25.101 for normal UMTS operation). TS 25.101 may refer to 3GPP TS 25.101-UE radio transmission and reception (FDD), which is incorporated herein by reference in its entirety. Accordingly, since the UARFCNs are unique, the present aspects provide a logical mapping between S-UMTS N=2 or N=4 and a specific FDD band. Consequently, the UARFCN may be explicitly signaled (as is done, for example, in conventional network operations), and there may be no need to explicitly signal the factor N. As such, no changes may need to be made to the conventional operation of various procedures such as the broadcasting of neighbor cell list information, measurement control procedures, mobility procedures, etc. In some present aspects, the UARFCNs of the one or more new FDD bands are unique among the one or more new FDD bands and also with respect to the corresponding existing normal UMTS FDD band, but may otherwise optionally be similar to the UARFCNs of other bands.

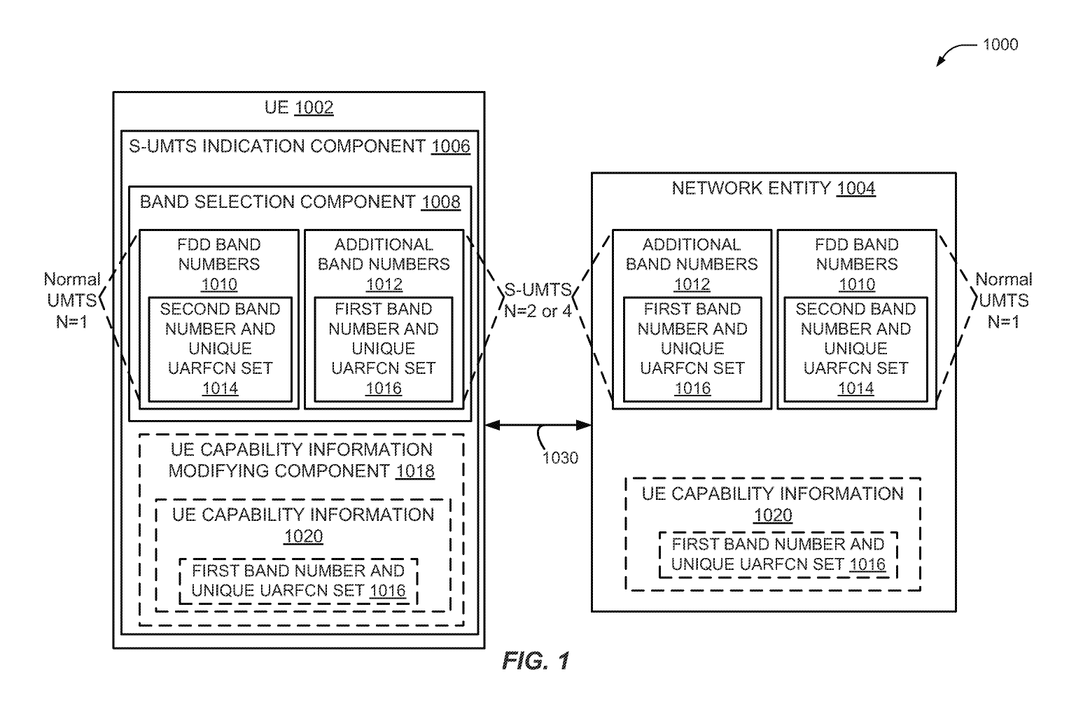

Referring to FIG. 1, in one aspect, system 1000 includes UE 1002 that is communicating with network entity 1004 (which may include a Node B and/or a radio network controller (RNC)) to indicate a network operation in S-UMTS (e.g., where the network operation may be a cell selection, a cell re-selection, and/or a radio resource control (RRC) connection establishment procedure). UE 1002 includes S-UMTS indication component 1006 that provides a signaling mechanism (e.g., via signals 1030) that makes it possible to differentiate between normal UMTS and S-UMTS N=2 and N=4 during network operation by defining one or more new FDD bands in, for example, TS 25.101, with unique UARFCN values relative to existing FDD bands. For example, S-UMTS indication component 1006 may include band selection component 1008 that selects a first band number and unique UARFCN set 1016 (from one or more additional band numbers 1012) that may be mapped to the same uplink and downlink frequency range of an existing FDD band used in normal UMTS, where the one or more additional band numbers 1012 are different from a second band number and unique UARFCN set 1014 assigned to the existing FDD band used in normal UMTS, and where each of the one or more additional band numbers 1012 corresponds to a specific factor N for use in UMTS scaling. The second band number and unique UARFCN set 1014 may be, for example, one of the existing FDD band numbers 1010 that are used in normal UMTS. During network operation (e.g., an RRC connection establishment procedure), UE 1002 may transmit a signal 1030 indicative of the first band number and unique UARFCN set 1016, where the signal 1030 indicates support of UMTS scaling operations in the FDD band for a specific factor N (e.g., corresponding to the same uplink and downlink frequency range as a second, band number and unique UARFCN set 1014 within an existing FDD band in normal UMTS). Also, during network operation (e.g., cell selection or cell re-selection), the UE 1002 may be pre-configured to select the first band number and unique UARFCN set 1016 in order to scan for S-UMTS N=2 or N=4 in a specific FDD band, during cell selection/re-selection before scanning for a second band, number and unique UARFCN set 1014 within an existing FDD band that is used in normal UMTS.

In some aspects, the network entity 1004 (which may include a Node B and/or an RNC) may receive a signal 1030 from UE 1002 and may determine support of UE 1002 for communications using UMTS scaling operations in an FDD band, based on the signal 1030. For example, network entity 1004 may determine that signal 1030 is indicative of the first band number and unique UARFCN set 1016. Further, network entity 1004 may determine the factor N corresponding to the first band number and unique UARFCN set 1016, and perform radio resource management operations based on the factor N. In some alternative or additional aspects, the network entity 1004 may transmit (e.g., broadcast) a signal 1030 that is indicative of the first band number and unique UARFCN set 1016. For example, the network entity 1004 may determine the first band number and unique UARFCN set 1016 and provide the signal 1030 that identifies the first band number and unique UARFCN set 1016 to indicate support for communications using UMTS scaling operations in an FDD band. In some aspects, the signal 1030 transmitted by network entity 1004 may include one or more of broadcast information, mobility information, measurement control information, and multi-carrier configuration signaling. In these aspects, network entity 1004 may further perform radio resource management based on a factor N corresponding to the first band number and unique UARFCN set 1016.

In an aspect, if the FDD band of interest for S-UMTS deployment is Band. VIII, then two new FDD bands may be defined (e.g., Band XXVII for S-UMTS N=2 and Band XXVIII for S-UMTS N=4 as illustrated in Table 1). The two new FDD bands may have the same set of uplink (UL) and downlink (DL) frequencies as Band VIII (assuming the channel raster is 200 kHz) but with UL and DL UARFCN formula offsets that are different from Band VIII. This may result in a set of UL and DL UARFCNs for S-UMTS N=2 and N=4 and, thereby, a logical mapping between S-UMTS N=2 and Band XXVII, and between S-UMTS N=4 and Band XXVIII. Accordingly, by using these newly defined bands, no changes may be needed to the current procedures such as the broadcasting of neighbor cell list information, PLMN selection (including cell selection/re-selection), measurement control procedures, mobility procedures, etc., since the UARFCNs for S-UMTS N=2 and S-UMTS N=4 are different from each other and from those of Band VIII. That is, the only change is the definition of two new bands (e.g., Band XXVII for S-UMTS N=2 and Band XXVIII for S-UMTS N=4) and the modification of ASN.1 coding in TS 25.331 to include these two new bands in the LIE capabilities information and to include the unique UARFCN corresponding to either of these two new bands in the signaling messages that include UARFCN information.

While some present aspects define two additional bands (e.g., one for N=2 and another for N=4) for S-UMTS deployment in Band VIII, other aspects of the disclosure need not be so limited. For example, fewer or more additional bands (with corresponding band numbers and a unique set of UARFCNs) may be defined for S-UMTS deployment in an existing FDD band for normal UMTS or for S-UMTS deployment in an FDD band with a downlink and uplink frequency range different from an existing normal UMTS FDD band (e.g., if S-UMTS is deployed in a frequency range not specified in TS 25.101 for normal UMTS operation). Each of these additional bands may correspond to a different factor N being used in UMTS scaling.

For each operating FDD band, the UARFCN values as currently defined in 3GPP TS 25.101 are:

N_{U}=5*(F_{UL}−F_{UL}_{_{—}}_{Offset}) for carrier frequency range F_{UL}_{_{—}}_{low}≦F_{UL}≦F_{UL}_{_{—}}_{high} (1)

N_{D}=5*(F_{DL}−F_{DL}_{_{—}}_{Offset}) for carrier frequency range F_{DL}_{_{—}}_{low}≦F_{DL}≦F_{DL}_{_{—}}_{high} (2)

Contingent upon the availability of contiguous UARFCN values, the formula for determining the UARFCN values may need to be modified as follows:

N_{U}=n*(F_{UL}−F_{UL}_{_{—}}_{Offset}) for carrier frequency range F_{UL}_{_{—}}_{low}≦F_{UL}≦F_{UL}_{_{—}}_{high} (3)

N_{D}=n*(F_{DL}−F_{DL}_{_{—}}_{Offset}) for carrier frequency range F_{DL}_{_{—}}_{low}≦F_{DL}≦F_{DL}_{_{—}}_{high} (4)

For example, n may be 15 instead of 5, Currently, the ASN.1 coding for the “UARFCN” IE in 3GPP TS 25.331 is UARFCN=INTEGER (0 . . . 16383). Currently, for the UL, the UARFCN range of ˜9900 to 13383 is free, and for the DL, the UARFCN range of ˜11000 to 16383 is free. The range can be expanded if necessary by increasing the Frequency Info IE INTEGER, from 14 bits to 15 bits (i.e., 0 . . . 32767). Accordingly, the present aspects may have little to no impact on 3GPP specifications.

TABLE 1
UARFCN general range (TS 25.101) with two
new FDD bands for S-UMTS N = 2 and N = 4

| | UL Low | UL High | DL Low | DL High |
|---|---|---|---|---|
| Band | UARFCN | UARFCN | UARFCN | UARFCN |
| XIX | 312 | 363 | 712 | 763 |
| XXI | 462 | 512 | 862 | 912 |
| III | 937 | 1288 | 1162 | 1513 |
| IV | 1312 | 1513 | 1537 | 1738 |
| VII | 2012 | 2338 | 2237 | 2563 |
| VIII | 2712 | 2863 | 2937 | 3088 |
| XI | 3487 | 3562 | 3712 | 3787 |
| XII | 3617 | 3678 | 3842 | 3903 |
| XIII | 3792 | 3818 | 4017 | 4043 |
| XIV | 3892 | 3918 | 4117 | 4143 |
| V | 4132 | 4233 | 4357 | 4458 |
| VI | 4162 | 4188 | 4387 | 4413 |
| XX | 4287 | 4413 | 4512 | 4638 |
| XXII | 4437 | 4813 | 4662 | 5038 |
| XXV | 4887 | 5188 | 5112 | 5413 |
| XXVI | 5537 | 5688 | 5762 | 5913 |
| II | 9262 | 9538 | 9662 | 9938 |
| I | 9612 | 9888 | 10562 | 10838 |
| XXVII | TBD | TBD | TBD | TBD |
| XXVIII | TBD | TBD | TBD | TBD |

In Table 1, contingent upon the availability of contiguous UL and DL UARFCN values, either formula (1) or (3) may be used to determine the UL UARFCN values, and either formula (2) or (4) may be used to determine DL UARFCN values for band XXVII (used for S-UMTS N=2) and band XXVIII (used for S-UMTS N=4). As noted herein, band XXVII may be simply referred, to by its number, that is, XXVII. Similarly, band XXVIII may be simply referred to by its number, that is, XXVIII.

Table 2 illustrates possible values for offsets F_{UL}_{_{—}}_{Offset} and F_{DL}_{_{—}}_{Offset} for both S-UMTS N=2 and N=4 for the example where the FDD band of interest for S-UMTS deployment is, for example, Band VIII.

TABLE 2
Frequency offset and range for Band VIII and two new FDD bands (Bands
XXVII and XXVIII)

| | UL (UE transmit, Node B | | | DL (UE receive, Node B | | |
|---|---|---|---|---|---|---|
| | receive) | | | transmit) | | |
| | F_{UL Offset} | F_{UL} (MHz) | | F_{DL Offset} | F_{DL} (MHz) | |
| Band | (MHz) | F_{UL}_{_{—}}_{low} | F_{UL}_{_{—}}_{high} | (MHz) | F_{DL}_{_{—}}_{low} | F_{DL}_{_{—}}_{high} |
| VIII | 340 | 882.4 | 912.6 | 340 | 927.4 | 957.6 |
| XXVII | TBD | 882.4 | 912.6 | TBD | 927.4 | 957.6 |
| XXVIII | TBD | 882.4 | 912.6 | TBD | 927.4 | 957.6 |

In Table 2, contingent upon the availability of contiguous UL UARFCN values, either formula (1) or (3) is used to determine the UL UARFCN values of F_{UL}_{_{—}}_{Offset} in bands XXVII and XXVIII. Also, contingent upon the availability of contiguous DL UARFCN values, either formula (2) or (4) is used to determine the DL UARFCN values of F_{DL}_{_{—}}_{Offset} in bands XXVII and XXVIII. Since the channel bandwidth for S-UMTS is scaled by 1/N, the carrier frequency range for the two new FDD bands (bands XXVII and XXVIII) may be extended relative to normal UMTS.

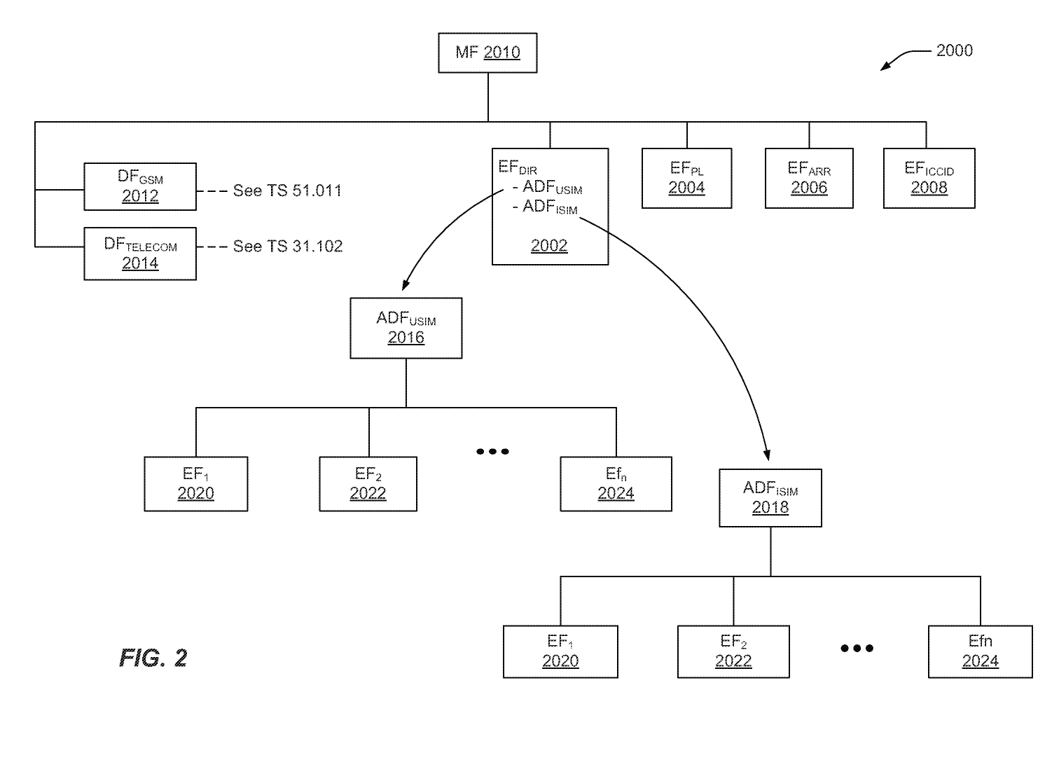

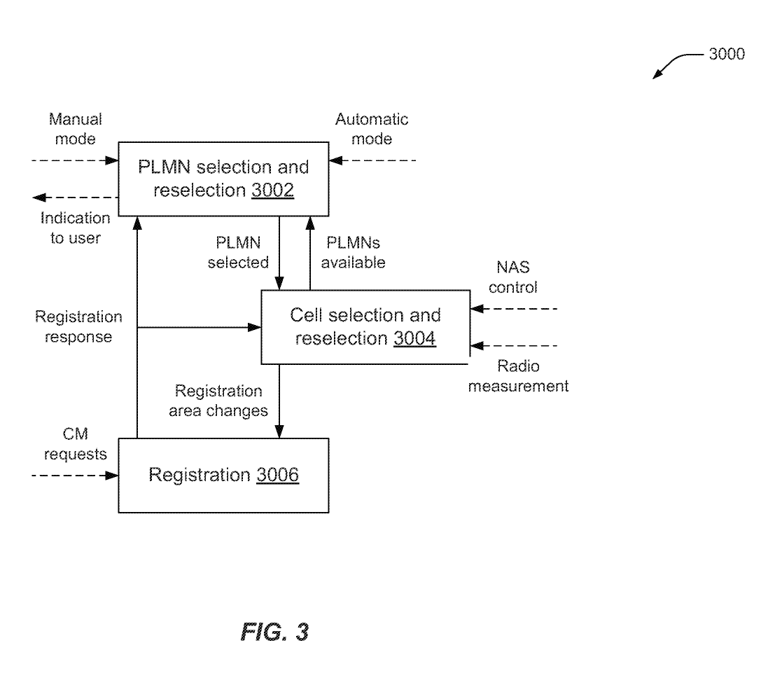

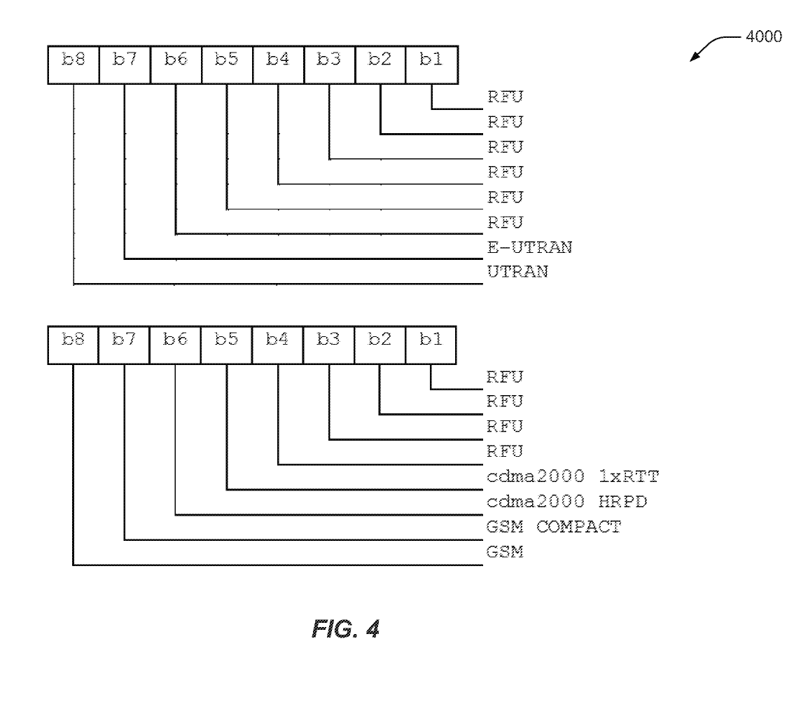

FIGS. 2-4 illustrate an example UICC application architecture 2000, an example idle mode process 3000, and an example access technology identifier coding 4000, respectively. The example UICC (i.e., smart card) application architecture 2000 of FIG. 2 includes a hierarchical file structure with the files being mapped to applications. The applications may be uniquely identified by application identifiers that are obtained from the Elementary File (EF) called. EF_{DIR} 2002. These application identifiers are used to select the application. EF_{DIR} 2002 and other EFs, e.g., EF_{PL} 2004, EF_{ARR} 2006, and EF_{ICCID} 2008, reside under the Master File (MF) 2010, A Dedicated File (DF), e.g., DF_{GSM} 2012 or DF_{TELECOM} 2014, allows for a functional grouping of files. The MF 2010 can be the parent of DFs and/or EFs. DFs are referenced by file identifiers. An Application DF (ADF), e.g. ADF_{USIM} 2016 or ADF_{ISIM} 2018, is a particular DF that includes the DFs and EFs of an application (e.g., the applications USIM or ISIM), such as EF₁2020, EF₂ 2022, and EFₙ 2024. Referring now to FIG. 3, the idle mode process 3000 includes PLMN selection and reselection 3002, cell selection and reselection 3004, and registration 3006. The USIM EFs used during PLMN selection procedure (e.g., in PLMN selection and reselection 3002) are EF_{IMSI}, EF_{PLMNwAcT} (service no 20, containing PLMN prioritization information with supported RATs), EF_{HPPLMN}, EF_{FPLMN}, EF_{LOCI} (containing RPLMN information), EF_{PSLOCI} (containing RPLMN information), EF_{OPLMwAcT} (service no 42, containing PLMN prioritization information with supported. RATs), EF_{HPLMNwAcT} (service no 43, containing PLMN prioritization information with supported RATs), EF_{NETPAR} (EF containing cell information), EF_{EHPLMN} (service no 71), EF_{LRPLMNSI} (service no 74, containing RPLMN information), and EF_{EPSLOCI} (containing RPLMN information). As shown in FIG. 4, in the access technology identifier coding 4000 (length=2 bytes), Bit=1 indicates access technology selected, and Bit=0 indicates access technology not selected, and RFU may be set to ‘0’. In the present aspects, in F_{PLMNwAcT} (service no 20), EF_{QPLMwAcT} (service no 42), and EF_{HPLMNwAcT} (service no 43), there may not be a need to define new Access Technology Identifiers for S-UMTS N=2 and 4 because the FDD band numbers and UARFCN for normal UMTS, S-UMTS N=2, and S-UMTS N=4 are different.

The present aspects may have no impact on UTRAN signaling (e.g., in TS 25.331) of broadcast information (e.g. via signals 1030 of FIG. 1). The UARFCN in the “Frequency info” information element (IE) (contained in the Inter-frequency cell info list IE) may be different for normal UMTS, S-UMTS N=2, and S-UMTS N=4 and may be included in the UTRAN RRC System Information blocks “System Information Block Type 11” and “System Information Block Type 12”. Since the UARFCN is unique and there is a logical mapping between S-UMTS N=2 or N=4 and a specific FDD band, the UTRAN may include the appropriate UARFCN in these UTRAN RRC System Information blocks to broadcast UE measurement control information for an S-UMTS N=2 or S-UMTS N=4 cell.

Also, the present aspects may have no impact on GERAN signalling of broadcast information (e.g. via signals 1030 of FIG. 1). If no PBCCH is present, the UARFCN in the “FDD-ARFCN” IE is included in the GERAN RRC System Information message “SYSTEM INFORMATION TYPE 2quater”. If a PBCCH is present, the UARFCN in the “FDD-ARFCN” IE is included in the GERAN RRC System Information message “PACKET SYSTEM INFORMATION TYPE 3quater”. Since the UARFCN is different and there is a logical mapping between S-UMTS N=2 or N=4 and a specific FDD band, the GERAN includes the appropriate UARFCN in these GERAN RRC System Information blocks if it wants to broadcast UE measurement control information for an S-UMTS N=2 or S-UMTS N=4 cell.

Further, the present aspects have no impact on E-UTRAN signalling of broadcast information. The UARFCN in the “ARFCN-Value UTRA” IE is included in the E-UTRAN RRC System Information block “System Information Block Type 6”. Since the UARFCN is different and there is a logical mapping between S-UMTS N=2 or N=4 and a specific FDD band, the E-UTRAN includes the appropriate UARFCN in this E-UTRAN RRC System Information block if it wants to broadcast UE measurement control information for an S-UMTS N=2 or S-UMTS N=4 cell.

In some present aspects, and still referring to FIG. 1, S-UMTS indication component 1006 may further include UE capability information modifying component 1018 that, in providing UE capability information 1020 in UTRAN Signalling (TS 25.331) in single carrier, includes new FDD bands such as first band number and unique UARFCN set 1016 (e.g., Band XXVII for S-UMTS N=2 and Band XXVIII for S-UMTS N=4 with a carrier frequency range that is greater than or equal to Band VIII) in the UTRAN RRC messages “RRC CONNECTION SETUP REQUEST”, “RRC CONNECTION SETUP COMPLETE”, or “UE CAPABILITY INFORMATION” message. In some aspects, since the channel bandwidth for S-UMTS is scaled by 1/N, the carrier frequency range for the two new FDD bands (Bands XXVII and XXVIII) may be extended relative to normal UMTS, resulting in a larger set of UL and DL frequencies relative to Band VIII. These UTRAN RRC messages contain the “UE radio access capability extension” IE which in turn contains the “Frequency band 3” IE (see e.g., TS 25.331, Section 10.3.3.42a). Currently, the ASN.1 coding for the “Frequency band 3” IE in 3GPP TS 25.331 is:
RadioFrequencyBandFDD3::=ENUMERATED {spare64, spare63, bandXXV, bandXXVI, spare60, spare59, spare58, spare57, spare56, spare55, spare54, spare53, spare52, spare51, spare50, spare49, spare48, spare47, spare46, spare45, spare44, spare43, spare42, spare41, spare40, spare39, spare38, spare37, spare36, spare35, spare34, spare33, spare32, spare31, spare30, spare29, spare28, spare27, spare26, spare25, spare24, spare23, spare22, spare21, spare20, spare19, spare18, spare17, spare16, spare15, spare14, spare13, spare12, spare11, spare10, spare9, spare8, spare7, spare6, spare5, spare4, spare3, spare2, extension-indicator}
   In order to support the present signalling aspects, the ASN.1 code may be modified to include Band XXVII and XXVIII as follows (e.g., use “spare60” and “spare59”):
RadioFrequencyBandFDD3::=ENUMERATED {spare64, spare63, bandXXV, bandXXVI, bandXXVII, bandXXVIII, spare58, spare57, spare56, spare55, spare54, spare53, spare52, spare51, spare50, spare49, spare48, spare47, spare46, spare45, spare44, spare43, spare42, spare41, spare40, spare39, spare38, spare37, spare36, spare35, spare34, spare33, spare32, spare31, spare30, spare29, spare28, spare27, spare26, spare25, spare24, spare23, spare22, spare21, spare20, spare19, spare18, spare17, spare16, spare15, spare14, spare13, spare12, spare11, spare10, spare9, spare8, spare7, spare6, spare5, spare4, spare3, spare2, ex tension-indicator}
   If the UE 1002 includes this information in either the RRC CONNECTION SETUP COMPLETE or UE CAPABILITY INFORMATION message, then the UTRAN knows that the UE is capable of supporting S-UMTS N=2 and/or S-UMTS N=4 in the same carrier frequency range as Band VIII.

In some present aspects, in providing UE capability information 1018 in UTRAN Signalling (TS 25.331) in dual-band, dual-carrier, UE capability information modifying component 1018 includes a new dual-band dual-carrier FDD band, combinations (e.g., Band I and Band XXVII for S-UMTS N==2 and Band I and Band XXVIII for S-UMTS N=4) in the RRC messages “RRC CONNECTION SETUP COMPLETE” and “UE CAPABILITY INFORMATION”. Both of these UTRAN RRC messages contain the “UE radio access capability” IE which in turn contains the “Band Combination” IE. Currently, the ASN.1 coding for the “Band. Combination” IE is:
BandComb::=INTEGER (1.256)
   In order to support the present S-UMTS time dilation signalling aspects, the ASN.1 coding for the “Band Combination” IE does not need to be modified. However, Table 5.0.0AA in TS 25.101 may be modified to include new DB-DC-HSDPA configurations (e.g., “6” for S-UMTS N=2 and “7” for S-UMTS N=4) as shown in Table 3.

TABLE 3
DB-DC-HSDPA configurations (modified for S-UMTS)

| DB-DC-HSDPA | | | |
|---|---|---|---|
| Configuration | UL Band | DL Band A | DL Band B |
| 1 | I or VIII | I | VIII |
| 2 | II or IV | II | IV |
| 3 | I or V | I | V |
| 4 | I or XI | I | XI |
| 5 | II or V | II | V |
| 6 | I | I | XXVII |
| 7 | I | I | XXVIII |

If the UE 1002 includes this information in either the “RRC CONNECTION SETUP COMPLETE” or “UE CAPABILITY INFORMATION” message, then the UTRAN knows that the UE; supports the dual-band dual-carrier FDD band combinations Band I and Band XXVII for S-UMTS X 2 and/or Band I and Band XXVIII for S-UMTS N=4.

The impact of the present aspects on GERAN Signalling (e.g., TS 44.018) of UE capability information 1020 is the same as for UTRAN signalling of UE capabilities described herein. The new bands are included in the GERAN RRC message “UTRAN CLASSMARK CHANGE”. This GERAN RRC message contains the “UTRAN Classmark” IE (see TS 44.018, Section 10.5.2.7a). For UTRA, the value part of the “UTRAN Classmark” IE is the UTRAN RRC message INTER RAT HANDOVER INFO as defined in TS 25.331, Section 10.2.16d. The INTER RAT HANDOVER INFO message contains the “UE radio access capability extension” IE which in turn contains the “Frequency band 3” IE as described herein with reference to UTRAN signalling of UE capabilities.

The impact of the present aspects on E-UTRAN Signalling (e.g., TS 36.331) of UE capability information 1020 may be the same as for UTRAN signalling of UE capabilities described, herein. The new bands are included, in the E-UTRAN RRC message “UE Capability Information”. This E-UTRAN RRC message contains the “UE-CapabilityRAT-Container” IE (which is contained in the “UE-CapabilityRAT-ContainerList” IE as defined in TS 36.331, Section 6.3.6). For UTRA, the octet string in the “UE-CapabilityRAT-Container” IE contains the UTRAN RRC message INTER RAT HANDOVER INFO as defined in TS 25.331, Section 10.2.16d. The INTER RAT HANDOVER INFO message contains the “UE radio access capability extension” IE which in turn contains the “Frequency band 3” IE as described herein with reference to UTRAN signalling of UE capabilities.

The present aspects may have no impact on UTRAN Signalling (e.g., TS 25.331) of mobility information. The UARFCN in the “Frequency info” IE is in included in the UTRAN RRC messages “PHYSICAL CHANNEL RECONFIGURATION”, “RADIO BEARER SETUP”, “RADIO BEARER RECONFIGURATION”, “RADIO BEARER RELEASE”, “TRANSPORT CHANNEL RECONFIGURATION”, and “HANDOVER TO UTRAN COMMAND”. Since the UARFCN are different and there is a logical mapping between S-UMTS N===2 or N==4 and a specific FDD band, the UTRAN includes the appropriate UARFCN in these UTRAN RRC messages if it wants the UE to perform a hard handover to either an S-UMTS N=2 or N=4 cell.

The present aspects may have no impact on GERAN signalling of mobility information. For GERAN circuit-switched inter-RAT handovers (to UTRAN), the “Handover to UTRAN Command” IE contains the UTRAN RRC message HANDOVER TO UTRAN COMMAND (see Section 2.2.1.3.1 of this contribution) and is included in the GERAN RRC message “INTER SYSTEM TO UTRAN HANDOVER COMMAND”. For GERAN packet-switched inter-RAT handovers (to UTRAN), the “PS Handover to UTRAN Payload” IE contains the UTRAN RRC message HANDOVER TO UTRAN COMMAND (as described, herein with reference to UTRAN signalling of mobility information) and is included in the GERAN RRC message “PS HANDOVER COMMAND”. For GERAN packet-switched inter-RAT cell change orders (to UTRAN), the UARFCN in the “FDD-ARFCN” IE is included in the GERAN RRC message “PACKET CELL CHANGE ORDER”. Since the UARFCN is different and there is a logical mapping between S-UMTS N=2 or N=4 and a specific FDD band, the UTRAN includes the appropriate UARFCN in these GERAN RRC messages if it wants the UE to perform a hard, handover to either an S-UMTS N=2 or N=4 cell.

The present aspects may have no impact on E-UTRAN signalling of mobility information. For E-UTRAN inter-RAT handover (to UTRAN), the “targetRAT-MessageContainer” IE contains the UTRAN RRC message HANDOVER TO UTRAN COMMAND (as described herein with reference to UTRAN signalling of mobility information) and is included in the E-UTRAN RRC message “MobilityFromEUTRACommand”. Since the UARFCN is different and there is a logical mapping between S-UMTS N=2 or N=4 and a specific FDD band, the UTRAN includes the appropriate UARFCN in this E-UTRAN RRC message if it wants the UE to perform a hard handover to either an S-UMTS N=2 or N=4 cell.

The present aspects may have no impact on UTRAN signalling of measurement control information. The UARFCN in the “Frequency info” IE is included in the UTRAN RRC message “MEASUREMENT CONTROL”. Since the UARFCN is different and there is a logical mapping between S-UMTS N=2 or N=4 and a specific FDD band, the UTRAN includes the appropriate UARFCN in this UTRAN RRC message if it wants the UE to perform measurements on an S-UMTS N=2 or S-UMTS N=4 cell.

The present aspects may have no impact on GERAN signalling of measurement control information. The UARFCN in the “FDD-ARFCN” IE is included in the GERAN RRC messages “MEASUREMENT INFORMATION” and “PACKET MEASUREMENT ORDER”. Since the UARFCN is different and there is a logical mapping between S-UMTS N=2 or N=4 and a specific FDD band, the GERAN includes the appropriate UARFCN in these GERAN RRC messages if it wants the UE to perform measurements on an S-UMTS N=2 or S-UMTS N=4 cell.

The present aspects may have no impact on E-UTRAN signalling of measurement control information. The UARFCN in the “ARFCN-ValueUTRA” IE is included in the E-UTRAN RRC message “RRCConnectionReconfiguration”. Since the UARFCN is different and there is a logical mapping between S-UMTS N=2 or N=4 and a specific FDD band, the E-UTRAN includes the appropriate UARFCN in this E-UTRAN RRC message if it wants the UE to perform measurements on an 8-UMTS N=2 or S-UMTS N=4 cell.

The present aspects may have no impact on Multicarrier Configuration Signalling. The UARFCN in the “UARFCN downlink (Nd)” IE is included in the UTRAN RRC messages “ACTIVE SET UPDATE”, “CELL UPDATE CONFIRM”, “PHYSICAL CHANNEL RECONFIGURATION”, “RADIO BEARER RECONFIGURATION”, “RADIO BEARER, RELEASE”, “RADIO BEARER SETUP”, “RRC CONNECTION SETUP”, and “TRANSPORT CHANNEL RECONFIGURATION”. Since the UARFCN is different and there is a logical mapping between S-UMTS N=2 or N=4 and a specific FDD band, the UTRAN includes the appropriate UARFCN in these UTRAN messages if it wants to configure multicarrier operation for the UE where the downlink secondary cell is either an S-UMTS N=2 or N=4 cell.

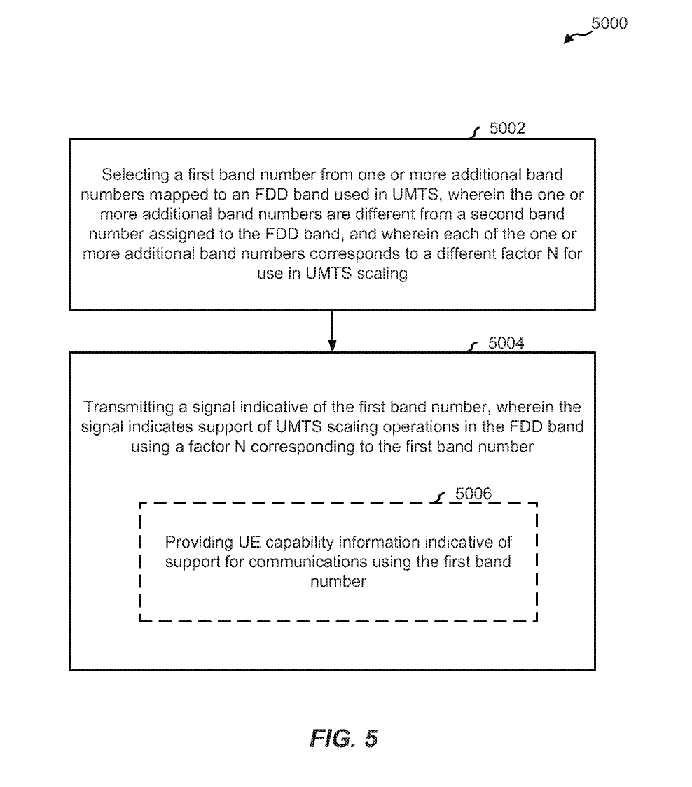

Referring to FIG. 5, in one aspect, a method 5000 for improving S-UMTS in wireless communication is illustrated. For explanatory purposes, method 5000 will be discussed with reference to the above described FIG. 1. It should be understood that in other implementations, other systems and/or UEs, Node Bs, or other apparatus comprising different components than those illustrated in FIG. 1 may be used in implementing method 5000 of FIG. 5.

At block 5002, method 5000 includes selecting a first band number from one or more additional band numbers mapped to an FDD band used in UMTS, where the one or more additional band numbers are different from a second band, number assigned to the FDD band, and where each of the one or more additional band numbers corresponds to a different factor N for use in UMTS scaling. For example, S-UMTS indication component 1006 may include band selection component 1008 that selects a first band number and unique UARFCN set 1016 from one or more additional band numbers 1012 (e.g., band numbers XXVII and XXVIII for FDD band VIII) mapped to an FDD band used in normal UMTS, where the one or more additional band numbers 1012 are different from a second band number and unique UARFCN set 1014 assigned to the FDD band (e.g., band number VIII), and where each of the one or more additional band numbers 1012 corresponds to a different factor N for use in UMTS scaling. In some aspects, each of the one or more additional band numbers 1012 may correspond to a unique set of UARFCNs relative to the FDD band. In some aspects, each of the one or more additional band numbers 1012 include a same or at least partially overlapping set of UL and DL frequencies as the FDD band, and the UL and DL UARFCN offsets corresponding to each of the one or more additional band numbers 1012 are different from the UL and DL UARFCN offsets of the FDD band (assuming that the formula used to determine the UARFCNs for the one or more additional band numbers is the same as that used for the normal UMTS FDD band). In some aspects, the FDD band comprises a UMTS Band VIII.

At block 5004, method 5000 includes transmitting a signal indicative of the first band number, where the signal indicates support of UMTS scaling operations in the FDD band using a factor N corresponding to the first band number. For example UE 1002 transmits a signal indicative of the first band number and unique UARFCN set 1016, where the signal indicates support of UMTS scaling operations in the FDD band (e.g., corresponding to the second band number and unique UARFCN set 1014 within existing FDD bands in UMTS) using a factor N corresponding to the first band number and unique UARFCN set 1016.

Optionally, block 5004 of method 5000 may include block 5006 to provide UE capability information indicative of support for communications using the first band number. For example, UE capability information modifying component 1018 may modify the UE capability information 1020 to indicate support for communications using the first hand number and unique UARFCN set 1016. In one aspect, for example, in providing UE capability information 1020 in UTRAN Signalling (TS 25.331) in single carrier, UE capability information modifying component 1018 includes new FDD bands such as first band number and unique UARFCN set 1016 (e.g., Band XXVII for S-UMTS N=2 and Band XXVIII for S-UMTS N=4 with a carrier frequency range that is greater than or equal to Band VIII) in the UTRAN RRC messages “RRC CONNECTION SETUP REQUEST”, “RRC CONNECTION SETUP COMPLETE”, or “UE CAPABILITY INFORMATION” message. In another aspects, for example, in providing UE capability information 1018 in UTRAN Signalling (TS 25.331) in dual-band dual-carrier, UE capability information modifying component 1018 includes a new dual-band dual-carrier FDD band combinations (e.g., Band I and Band XXVII for S-UMTS N=2 and Band I and Band XXVIII for S-UMTS N=4) in the RRC messages “RRC CONNECTION SETUP COMPLETE” and “UE CAPABILITY INFORMATION”. In a further aspect, for example, in providing UE capability information 1018 in GERAN Signalling, UE capability information modifying component 1018 includes the new bands, e.g., the first band number and unique UARFCN set 1016, in the GERAN RRC message “UTRAN CLASSMARK CHANGE”. In yet another aspect, for example, in providing UE capability information 1018 in E-UTRAN Signalling, UE capability information modifying component 1018 includes the new bands, e.g., the first band number and unique UARFCN set 1016, in a UE Capability Information message or a E-UTRAN RRC message. Signaling of UE capability may be provided by, for example, signals 1030 of FIG. 1.

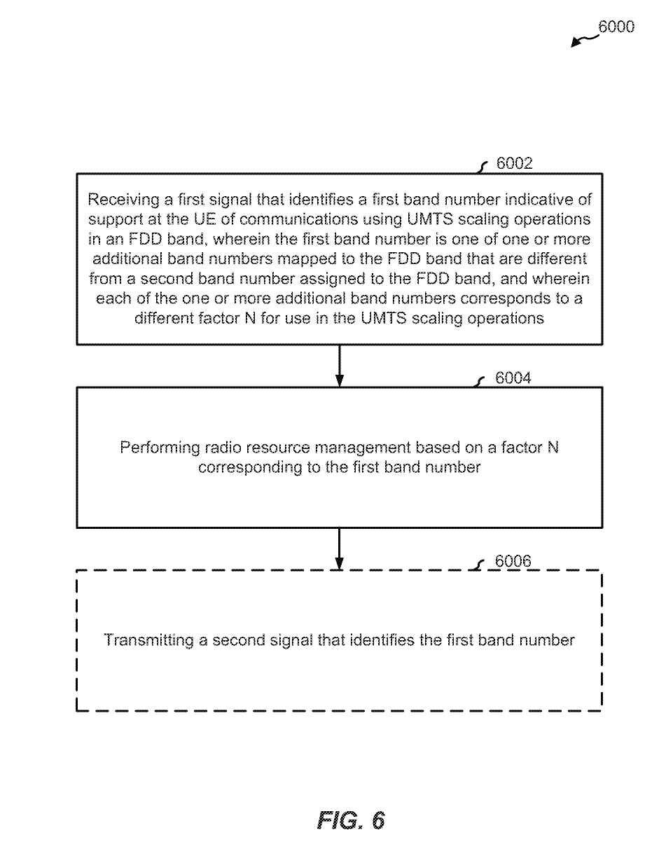

Referring to FIG. 6, in one aspect, another method 6000 for improving S-UMTS in wireless communication is illustrated. For explanatory purposes, method 6000 will be discussed with reference to the above described FIG. 1. It should be understood that in other implementations, other systems and/or UEs, Node Bs, or other apparatus comprising different components than those illustrated in FIG. 1 may be used in implementing method 6000 of FIG. 6.

At block 6002, method 6000 includes receiving, from a UE, a first signal that identifies a first band number indicative of support at the UE of communications using UMTS scaling operations in an FDD band, where the first band, number is one of one or more additional band numbers mapped to the FDD band that are different from a second band number assigned to the FDD band, and where each of the one or more additional band numbers corresponds to a different factor N for use in the UMTS scaling operations. For example, network entity 1004 may receive the signal 1030 from UE 1002 that identifies first band number and unique UARFCN set 1016 to indicate support at UE 1002 of communications using UMTS scaling operations in an FDD band. For example, first band number and unique UARFCN set 1016 may be one of the one or more additional band numbers 1012 (e.g., band numbers XXVII and XXVIII for FDD band VIII) mapped to an FDD band used in normal UMTS, where the one or more additional band numbers 1012 are different from a second band number and unique UARFCN set 1014 assigned to the FDD band (e.g., band number VIII), and where each of the one or more additional band numbers 1012 corresponds to a different factor N for use in UMTS scaling. In some aspects, the signal 1030 may include UE capability information of UE 1002 that identifies first band number and unique UARFCN set 1016.

At block 6004, method 6000 includes performing radio resource management based on a factor N corresponding to the first band number. For example, network entity 1004 may perform radio resource management based on a factor N corresponding to the first band number and unique UARFCN set 1016.

Optionally, at block 6006, method 6000 includes transmitting a second signal that identifies the first band number. For example, network entity 1004 may transmit (e.g., broadcast) a second signal (e.g., via signals 1030) that identifies the first band number and unique UARFCN set 1016. In some aspects, the second signal may include one or more of broadcast information, mobility information, measurement control information, and multi-carrier configuration signaling.

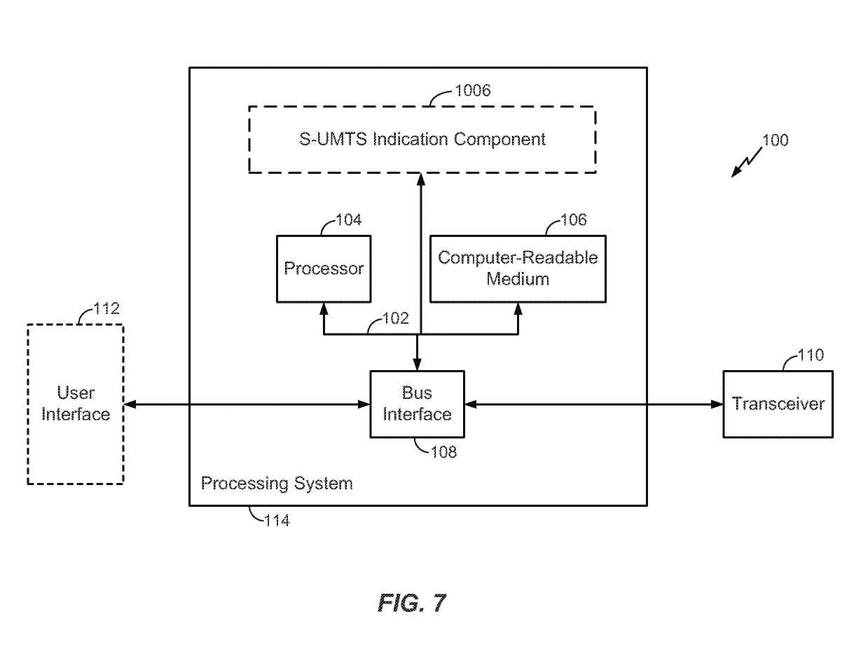

FIG. 7 is a conceptual diagram illustrating an example of a hardware implementation for an apparatus 100 employing a processing system 114 to operate, for example, UE 1002, Node B 1004, S-UMTS indication component 1006 (see FIG. 1), and/or respective components thereof. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided. As noted above, apparatus 100 further includes S-UMTS indication component 1006 (see FIG. 1) that is linked by bus 102 to other components of apparatus 100.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software. In some aspects, at least some of the functions or features supported by S-UMTS indication component 1006 may be implemented, performed, or executed, by the processor 104 in connection with the computer-readable medium 106.

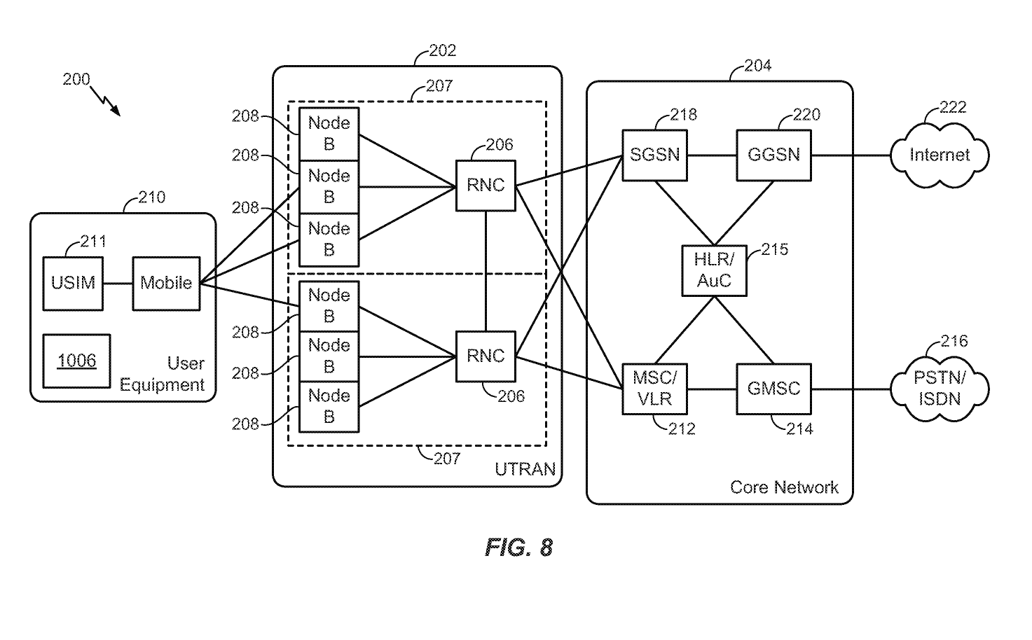

The various concepts presented throughout this disclosure may be implemented across a broad, variety of telecommunication systems, network architectures, and communication standards. By way of example and without limitation, the aspects of the present disclosure illustrated in FIG. 8 are presented with reference to a UMTS system 200 employing a W-CDMA air interface. A UMTS network includes three interacting domains: a Core Network (CM) 204, a UMTS Terrestrial Radio Access Network (UTRAN) 202, and User Equipment (UE) 210. The UTRAN 202 may include the Node B 1004 of FIG. 1 and the UE 210 may be an example of the UE 1002 of FIG. 1. The UE 210 may include S-UMTS indication component 1006 or the apparatus 100 of FIG. 7 which includes S-UMTS indication component 1006. In some aspects, for example, S-UMTS indication component 1006 of the UE 210 may select a first band number from one or more additional band numbers mapped to an FDD band used in UMTS, where the one or more additional band numbers are different from a second band number assigned to the FDD band, and wherein each of the one or more additional band numbers corresponds to a different factor N for use in UMTS scaling, and UE 210 may transmit a signal indicative of the first band number, wherein the signal indicates support of UMTS scaling operations in the FDD band using a factor N corresponding to the first band, number.

In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in Radio Resource Control (RRC) Protocol Specification, 3GPP TS 25.331 v9.1.0, incorporated herein by reference.

The geographic region covered by the SRNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each SRNS 207; however, the SRNSs 207 may include any number of wireless Node Bs. The Node Bs 208 provide wireless access points to a core network (CN) 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210, and the uplink (UL), also called the reverse link, refers to the communication link from a UE 210 to a Node B 208.

The core network 204 interfaces with one or more access networks, such as the UTRAN 202. As shown, the core network 204 is a GSM core network. However, as those skilled in the art will recognize, the various concepts presented throughout this disclosure may be implemented in a RAN, or other suitable access network, to provide UEs with access to types of core networks other than GSM networks.

The core network 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the core network 204 supports circuit-switched, services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched, network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The core network 204 also supports packet-data services with a serving GPRS support node (SGSN) 218 and a gateway GPRS support node (GGSN) 220. GPRS, which stands for General Packet Radio Service, is designed, to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

The UMTS air interface is a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such direct sequence spread spectrum technology and additionally calls for a frequency division duplexing (FDD). FDD uses a different carrier frequency for the uplink (UL) and downlink (DL) between a Node B 208 and a UE 210. Another air interface for UMTS that utilizes DS-CDMA, and uses time division duplexing, is the TD-SCDMA air interface. Those skilled in the art will recognize that although various examples described herein may refer to a WCDMA air interface, the underlying principles are equally applicable to a TD-SCDMA air interface.

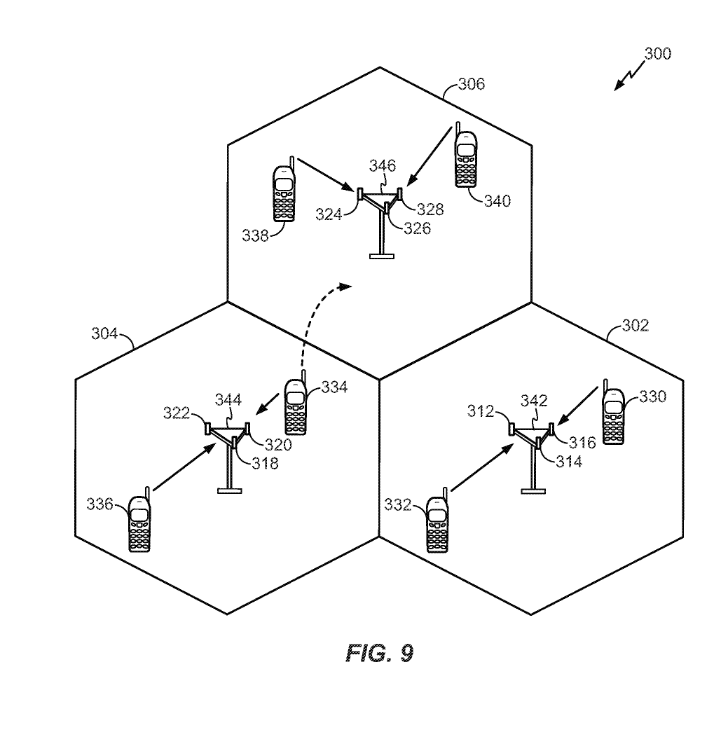

Referring to FIG. 9, an access network 300 in a UTRAN architecture is illustrated in which one or more of the wireless communication entities, e.g., UEs and/or base stations, may include UE 1002, 210, Node B 1004, 208, S-UMTS indication component 1006, or apparatus 100 (see FIGS. 1, 7, and 8). For example, in an aspect, UEs 330, 332, 334, 336, 338, and 340 may include S-UMTS indication component 1006 of the UE 210 in FIG. 8, which may select a first band number from one or more additional band, numbers mapped to an FDD band used in UMTS, where the one or more additional band numbers are different from a second band number assigned to the FDD band, and wherein each of the one or more additional band numbers corresponds to a different factor N for use in UMTS scaling, and a respective one of UEs 330, 332, 334, 336, 338, 340 may transmit a signal indicative of the first band number, where the signal indicates support of UMTS scaling operations in the FDD band using a factor N corresponding to the first band number.

The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g. User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a core network 204 (see FIG. 8) for all the UEs 330, 332, 334, 336, 338, 340 in the respective cells 302, 304, and 306.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 8), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LIE, LIE Advanced, and GSM are described in documents from the 3GPP organization. CDMA2000 and UMB are described, in documents from the 3GPP2 organization. The actual wireless communication standard and the multiple access technology employed will depend on the specific application and the overall design constraints imposed on the system.

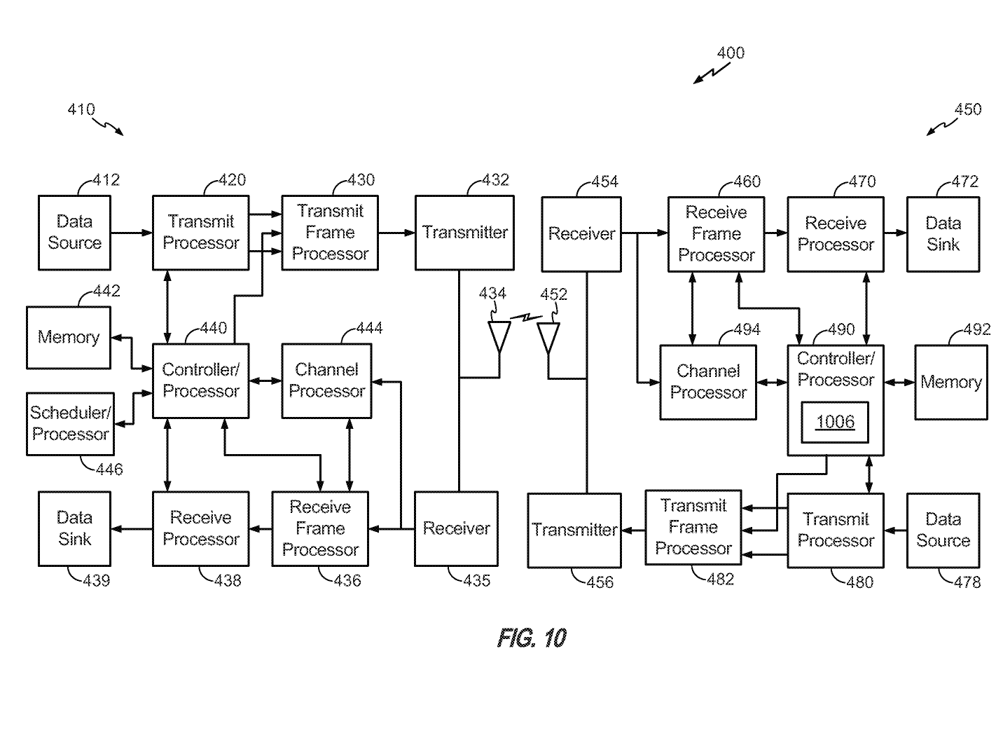

FIG. 10 is a block diagram of a Node B 410 in communication with a UE 450, where the Node B 410 may be the Node B 208 in FIG. 8 or Node B 1004 in FIG. 1, and the UE 450 may be the UE 210 in FIG. 8 or UE 1002 in FIG. 1. The UE 450 may include S-UMTS indication component 1006, or the apparatus 100 of FIG. 7 which includes S-UMTS indication component 1006. In some aspects, for example, S-UMTS indication component 1006 of the UE 450 may select a first band number from one or more additional band numbers mapped to an FDD band used in UMTS, where the one or more additional band numbers are different from a second band number assigned to the FDD band, and wherein each of the one or more additional band, numbers corresponds to a different factor N for use in UMTS scaling, and UE 450 may transmit a signal indicative of the first band number, where the signal indicates support of UMTS scaling operations in the FDD band using a factor N corresponding to the first band, number.

In the downlink communication, a transmit processor 420 may receive data from a data source 412 and control signals from a controller/processor 440. The transmit processor 420 provides various signal processing functions for the data and control signals, as well as reference signals (e.g., pilot signals). For example, the transmit processor 420 may provide cyclic redundancy check (CRC) codes for error defection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 444 may be used by a controller/processor 440 to determine the coding, modulation, spreading, and/or scrambling schemes for the transmit processor 420. These channel estimates may be derived from a reference signal transmitted by the UE 450 or from feedback from the UE 450. The symbols generated by the transmit processor 420 are provided to a transmit frame processor 430 to create a frame structure. The transmit frame processor 430 creates this frame structure by multiplexing the symbols with information from the controller/processor 440, resulting in a series of frames. The frames are then provided to a transmitter 432, which provides various signal conditioning functions including amplifying, filtering, and modulating the frames onto a carrier for downlink transmission over the wireless medium through antenna 434. The antenna 434 may include one or more antennas, for example, including beam steering bidirectional adaptive antenna arrays or other similar beam technologies.

At the UE 450, a receiver 454 receives the downlink transmission through an antenna 452 and processes the transmission to recover the information modulated onto the carrier. The information recovered by the receiver 454 is provided to a receive frame processor 460, which parses each frame, and provides information from the frames to a channel processor 494 and the data, control, and reference signals to a receive processor 470. The receive processor 470 then performs the inverse of the processing performed by the transmit processor 420 in the Node B 410. More specifically, the receive processor 470 descrambles and despreads the symbols, and then determines the most likely signal constellation points transmitted by the Node B 410 based on the modulation scheme. These soft decisions may be based on channel estimates computed by the channel processor 494. The soft decisions are then decoded, and deinterleaved to recover the data, control, and reference signals. The CRC codes are then checked to determine whether the frames were successfully decoded. The data carried by the successfully decoded frames will then be provided to a data sink 472, which represents applications running in the UE 450 and/or various user interfaces (e.g., display). Control signals carried by successfully decoded frames will be provided to a controller/processor 490. When frames are unsuccessfully decoded, by the receiver processor 470, the controller/processor 490 may also use an acknowledgement (ACK) and/or negative acknowledgement (NACK) protocol to support retransmission requests for those frames.

In the uplink, data from a data source 478 and control signals from the controller/processor 490 are provided to a transmit processor 480. The data source 478 may represent applications running in the UE 450 and various user interfaces (e.g., keyboard). Similar to the functionality described in connection with the downlink transmission by the Node B 410, the transmit processor 480 provides various signal processing functions including CRC codes, coding and interleaving to facilitate FEC, mapping to signal constellations, spreading with OVSFs, and scrambling to produce a series of symbols. Channel estimates, derived by the channel processor 494 from a reference signal transmitted by the Node B 410 or from feedback contained in the midamble transmitted by the Node B 410, may be used, to select the appropriate coding, modulation, spreading, and/or scrambling schemes. The symbols produced by the transmit processor 480 will be provided to a transmit frame processor 482 to create a frame structure. The transmit frame processor 482 creates this frame structure by multiplexing the symbols with information from the controller/processor 490, resulting in a series of frames. The frames are then provided to a transmitter 456, which provides various signal conditioning functions including amplification, filtering, and modulating the frames onto a carrier for uplink transmission over the wireless medium through the antenna 452.

The uplink transmission is processed at the Node B 410 in a manner similar to that described in connection with the receiver function at the UE 450. A receiver 435 receives the uplink transmission through the antenna 434 and processes the transmission to recover the information modulated onto the carrier. The information recovered by the receiver 435 is provided to a receive frame processor 436, which parses each frame, and provides information from the frames to the channel processor 444 and the data, control, and reference signals to a receive processor 438. The receive processor 438 performs the inverse of the processing performed by the transmit processor 480 in the UE 450. The data and control signals carried by the successfully decoded frames may then be provided, to a data sink 439 and the controller/processor, respectively. If some of the frames were unsuccessfully decoded by the receive processor, the controller/processor 440 may also use an acknowledgement (ACK) and/or negative acknowledgement (NACK) protocol to support retransmission requests for those frames.

The controller/processors 440 and 490 may be used to direct the operation at the Node B 410 and the UE 450, respectively. For example, the controller/processors 440 and 490 may provide various functions including timing, peripheral interfaces, voltage regulation, power management, and other control functions. The computer readable media of memories 442 and 492 may store data and software for the Node B 410 and the UE 450, respectively. A scheduler/processor 446 at the Node B 410 may be used, to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described, functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited, to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communications, comprising:
selecting a first band, number from one or more additional band numbers mapped to a frequency division duplexing (FDD) band used in universal mobile telecommunications (UMTS), wherein the one or more additional band, numbers are different from a second band number assigned to the FDD band, and wherein each of the one or more additional band, numbers corresponds to a different factor N for use in UMTS scaling; and
transmitting a signal indicative of the first band number, wherein the signal indicates support of UMTS scaling operations in the FDD band using a factor N corresponding to the first band number.

2. The method of claim 1, wherein each of the one or more additional band numbers corresponds to a unique set of UTRA absolute radio frequency channel numbers (UARFCN) relative to the FDD band.

3. The method of claim 1, wherein each of the one or more additional band numbers comprises a same or at least partially overlapping set of uplink (UL) and downlink (DL) frequencies as the FDD band, and wherein the UL and DL UTRA absolute radio frequency channel number (UARFCN) offsets corresponding to each of the one or more additional band numbers are different from the UL and DL UARFCN offsets of the FDD band.

4. The method of claim 1, wherein the FDD band comprises a UMTS Band VIII.

5. The method of claim 1, wherein transmitting the signal comprises:
providing user equipment (UE) capability information indicative of support for communications using the first band number.

6. The method of claim 5, wherein the UE capability information is provided in UTRAN signaling in single earner that includes an RRC CONNECTION SETUP REQUEST message, an RRC CONNECTION SETUP COMPLETE message, or a UE CAPABILITY INFORMATION message, and wherein the UE capability information comprises the first band number with a carrier frequency range that is greater than or equal to the FDD band.

7. The method of claim 5, wherein the UE capability information is provided in UTRAN signaling in dual-band dual-carrier that includes an RRC CONNECTION SETUP COMPLETE message or a UE CAPABILITY INFORMATION message, and wherein the UE capability information comprises a dual-band dual-carrier band number combination that includes the first band number.

8. The method of claim 5, wherein the UE capability information is provided in GERAN signaling that includes a UTRAN CLASSMARK CHANGE GERAN RRC message, and wherein the UE capability information comprises the first band number.

9. The method of claim 5, wherein the UE capability information is provided in E-UTRAN signaling that includes a UE Capability Information message or a E-UTRAN RRC message, and wherein the UE capability information comprises the first band number.

10. An apparatus for wireless communications, comprising:
a processing system configured to:
select a first band number from one or more additional band numbers mapped to a frequency division duplexing (FDD) band used in universal mobile telecommunications (UMTS), wherein the one or more additional band numbers are different from a second band number assigned to the FDD band, and wherein each of the one or more additional band numbers corresponds to a different factor N for use in UMTS scaling; and
transmit a signal indicative of the first band number, wherein the signal indicates support of UMTS scaling operations in the FDD band using the factor N corresponding to the first band number.

11. The apparatus of claim 10, wherein each of the one or more additional band numbers corresponds to a unique set of UTRA absolute radio frequency channel numbers (UARFCN) relative to the FDD band.

12. The apparatus of claim 10, wherein each of the one or more additional band numbers comprises a same set of uplink (UL) and downlink (DL) frequencies as the FDD band, wherein the UL and DL UTRA absolute radio frequency channel number (UARFCN) offsets corresponding to each of the one or more additional band numbers are different from the UL and DL UARFCN offsets of the FDD band, and wherein a formula used to determine UARFCNs for the one or more additional band numbers is the same as that used for the FDD band.

13. The apparatus of claim 10, wherein the FDD band comprises a UMTS Band VIII.

14. The apparatus of claim 10, wherein the processor is configured to transmit the signal by:
providing user equipment (UE) capability information indicative of support for communications using the first band number.

15. The apparatus of claim 14, wherein the UE capability information is provided in UTRAN signaling in single carrier that includes an RRC CONNECTION SETUP REQUEST message, an RRC CONNECTION SETUP COMPLETE message, or a UE CAPABILITY INFORMATION message, and wherein the UE capability information comprises the first band number with a carrier frequency range that is greater than or equal to the FDD band.

16. The apparatus of claim 14, wherein the UE capability information is provided in one or more of:
UTRAN signaling in dual-band dual-carrier that includes an RRC CONNECTION SETUP COMPLETE message or a UE CAPABILITY INFORMATION message, wherein the UE capability information comprises a dual-band dual-carrier hand number combination that includes the first band number;
GERAN signaling that includes a UTRAN CLASSMARK CHANGE GERAN RRC message, wherein the UE capability information comprises the first band number; and
E-UTRAN signaling that includes a UE Capability Information message or a E-UTRAN RRC message, wherein the UE capability information comprises the first band number.

17. A method for wireless communications, comprising:
receiving, from a user equipment (UE), a first signal that identifies a first band number indicative of support at the UE of communications using universal mobile telecommunications (UMTS) scaling operations in a frequency division duplexing (FDD) band, wherein the first band number is one of one or more additional band, numbers mapped to the FDD band that are different from a second band number assigned to the FDD band, and wherein each of the one or more additional band numbers corresponds to a different factor N for use in the UMTS scaling operations; and
performing radio resource management based on a factor N corresponding to the first band number.

18. The method of claim 17, wherein the first signal comprises UE capability information that identifies the first band number.

19. The method, of claim 17, further comprising:
transmitting a second signal that identifies the first band number.

20. The method of claim 19, wherein the second signal comprises one or more of broadcast information, mobility information, measurement control information, and multi-carrier configuration signaling.
